(19) United States
(12) Patent Application Publication
(10) Pub. No.: US 2015/0213590 A1
(43) Pub. Date: Jul. 30, 2015

(54) Automatic Pose Setting Using Computer Vision Techniques

(71) Applicants: Brian Gammon BROWN, Longmont, CO (US); Zhe FAN, Boulder, CO (US); Scott SHATTUCK, Westminster, CO (US); Matt LOWRIE, Louisville, CO (US)

(72) Inventors: Brian Gammon BROWN, Longmont, CO (US); Zhe FAN, Boulder, CO (US); Scott SHATTUCK, Westminster, CO (US); Matt LOWRIE, Louisville, CO (US)

(73) Assignee: Google Inc., Mountain View, CA (US)

(21) Appl. No.: 13/193,861

(22) Filed: Jul. 29, 2011

(51) Int. Cl. G06T 7/00; G06T 19/20; G06T 17/05; G06T 15/20; G06T 17/10

(52) U.S. Cl. CPC G06T 7/003; G06T 7/0032; G06T 15/205; G06T 7/0065; G06T 17/10; G06T 17/05; G06T 19/20; G06T 7/0044; G06T 2207/20108; G06T 2219/2021; G06T 2210/32; G06T 2210/04; G06T 2207/30244

(57) ABSTRACT

Embodiments relate to determining pose data for a user-provided image. A user may model a building in a web browser plug in by mapping positions on two-dimensional images to a three-dimensional model of a building shown in the image. A geometry of the model of the building may be determined. The user may then provide an image that includes the building. One or more features of the selected building in the user-provided image may be detected using computer vision techniques. Detected features are correlated with features of the geometry of the three-dimensional model. Based on the correlation, pose data may be associated with the user-provided image.

### BACKGROUND

1. Field

This field is generally related to photogrammetry.

2. Related Art

Three-dimensional modeling tools and other computer-aided design (CAD) tools enable users to define three-dimensional models, such as a three-dimensional model of a building. Photographic images of the building may be available from, for example, satellite, aerial, vehicle-mounted street-view and user cameras. The photographic images of the building may be texture mapped to the three-dimensional model to create a more realistic rendering of the building.

### BRIEF SUMMARY

Embodiments relate to determining pose data for a user-provided image. In an embodiment, a user input comprising a user-selected location is received. A plurality of images showing one or more buildings at the user-selected location is provided. A second user input mapping a selected position on a two-dimensional image in the plurality of images to a feature of a three-dimensional shape for a selected building in the two-dimensional image is received. A geometry of a three-dimensional model of the selected building is determined, based on the mapping, such that when the three-dimensional model is rendered with the two-dimensional image from a perspective specified by a pose of the two-dimensional image, the feature of the three-dimensional model appear at the selected position of the two-dimensional image. A user-provided image is received. One or more features of the selected building in the user-provided image are detected. The detected features are correlated with features of the geometry of the three-dimensional model. Based on the correlation, pose data representing at least a position and orientation of the user-provided image is determined, such that when the three-dimensional model is rendered with the user-provided image from a perspective specified by the pose data, each of the one or more features of the geometry of the three-dimensional model appear at the correlated detected feature of the selected building in the user-provided image.

Systems and computer program products for determining pose data for a use-provided image are also described.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram illustrating construction of a three-dimensional model using a plurality of two-dimensional images.

FIG. 2 is a diagram illustrating creating a three-dimensional model from user selections in two-dimensional images.

FIG. 3 is a flowchart showing a method for determining pose data for a user-provided image.

FIG. 4 is a diagram showing a system for determining pose data for a user-provided image.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments relate to determining pose data for an image provided by a user. A user may model a building in a web browser plug in. The user may be presented with a set of two-dimensional images displaying a particular building to be modeled. A user may specify various three-dimensional shapes that correspond to the building, such as boxes, gables, pyramids, or other shapes. In the process of specifying the three-dimensional shapes, the user may correlate or constrain points of the three-dimensional shape to points on a two-dimensional image. Based on the mapping, a geometry of a three-dimensional model of the building may be determined.

The user may then supply an image from, for example, her camera. Features of the building in the user's image are detected and correlated with features of the three-dimensional model of the building. Based on the correlation, pose data may be associated with the user's image. The user's image may then be used for modeling by constraining points of three-dimensional shapes to points on the image.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

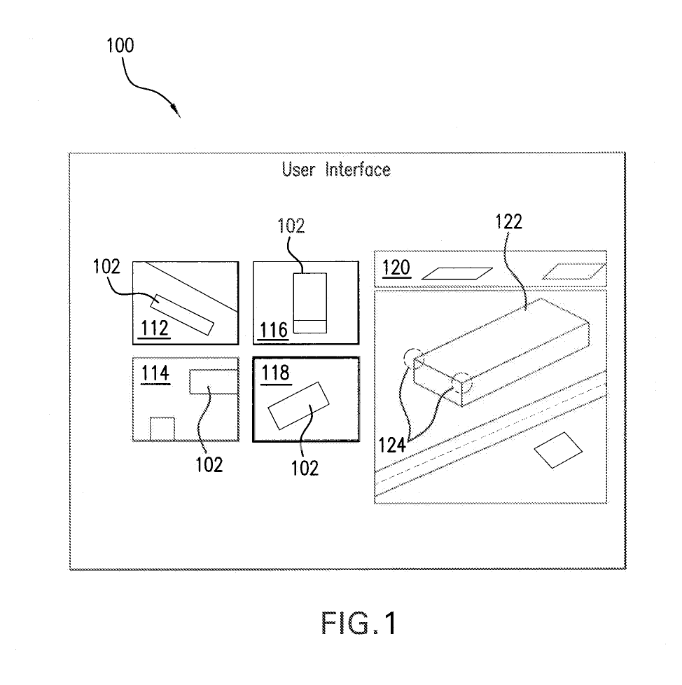

FIG. 1 shows a diagram showing a user interface 100 of an image-based modeling service for creating a three-dimensional model from two-dimensional images. As described below, user interlace 100 may, in an embodiment, be a web based user interface. In the embodiment, a server may serve to a client data, such as Hypertext markup language (HTML) data, JavaScript, or animation data, specifying user interface 100. Using such data, the client may render and display user interface 100 to a user.

User interface 100 includes images 112, 114, 116, and 118 of a building 102. Each of images 112, 114, 116, and 118 is a photographic image capturing building 102 from a different perspective. Each of images 112, 114, 116, and 118 may be an aerial or satellite image and may have oblique and nadir images. Further, one or more of images 112, 114, 116, and 118 may be a photographic image captured from street level, such as a portion of a panoramic image captured from a vehicle in motion. Each of images 112, 114, 116 and 118 may have associated original pose data, which includes information related to a position and orientation of a camera which captured each image. Each of images 112, 114, 116, and 118 may be displayed with an indication (such as a colored outline) indicating whether a user constraint has been received for the image. Constraints may indicate points defined by an x, y, and z value. Constraints may map a position on an image to a three-dimensional model of the building 102.

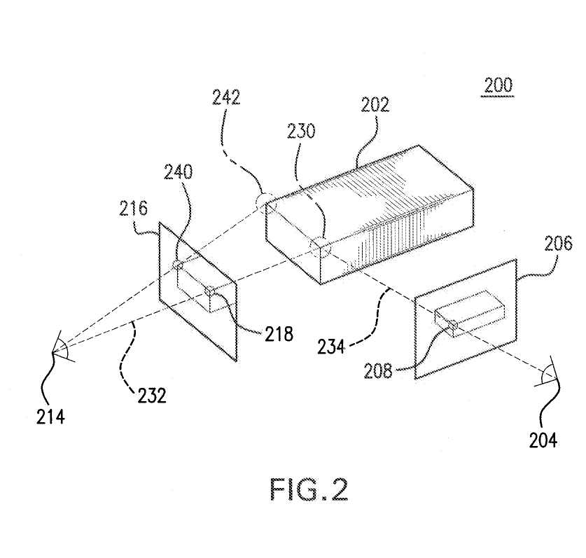

In an example, a user may select one of images 112, 114, 116, and 118 to display in a viewport 120. In viewport 120, a three-dimensional model 122 may be displayed. Three-dimensional model 122 may be displayed, for example, as a wireframe structure so as to avoid obscuring the photographic image in viewport 120. By selecting points, such as points 124, on three-dimensional model 122, a user may constrain three-dimensional model 122 to the image in viewport 120. More specifically, a user may indicate that a position on the three-dimensional model corresponds to a position on the photographic image in viewport 120. By inputting constraints for the plurality of images 112, 114, 116, and 118, a user can specify where three-dimensional model 122 appears in each of the images. Based on the user specifications, the geometry of three-dimensional model 122 may be determined using a photogrammetry algorithm as illustrated in FIG. 2. In this way, a user may define three-dimensional model 122 to model building 102 using images of the building.

FIG. 2 shows a diagram 200 illustrating creating a three-dimensional model from user selections in two-dimensional images. Diagram 200 shows a three-dimensional model 202 and multiple photographic images 216 and 206 of a building. Images 216 and 206 were captured from cameras having different perspectives, as illustrated by camera 214 and 204. As mentioned above, a user may input constraints on images 216 and 206, such as constraints 218 and 208, and those constraints may be used to determine the geometry of three-dimensional model 202. The geometry of three-dimensional model 202 may be specified by a set of geometric parameters, representing, for example, a position of an origin point (e.g., x, y, and z coordinates), a scale (e.g., height and width), an orientation (e.g., pan, tilt, and roll). Depending on a shape of three-dimensional model 202 (e.g., box, gable, hip, pyramid, top-flat pyramid, or ramp) additional geometric parameters may be needed. For example, to specify the geometry of a gable, the angle of the gable's slopes or a position of the gable's tip may be included in the geometric parameters.

To determine the geometry of three-dimensional model 202, the user constraints from the images may be used to determine rays in three-dimensional space and the rays are used to determine the geometry. In diagram 200, a ray 232 may be determined based on user constraint 218, and a ray 234 may be determined based on a user constraint 208. Rays 232 and 234 are constructed based on parameters associated with cameras 214 and 204 respectively. For example, ray 232 may be extended from a focal point or entrance pupil of camera 214 through a point corresponding to user constraint 218 at a focal length distance from the focal point of camera 214. Similarly, ray 234 may be extended from a focal point or entrance pupil of camera 204 through a point corresponding to user constraint 208 at a focal length distance from the focal point of camera 204. Using rays 232 and 234, a position 230 on three-dimensional model 202 may be determined. This process is known as photogrammetry. In this way, the geometry of three-dimensional model 202 may be determined based on user constraints 218 and 208, and parameters representing cameras 214 and 204.

However, the parameters, or pose data, representing cameras 214 and 204 may not be accurate. In an embodiment, the pose data may include a position, orientation (e.g., pan, tilt, and roll), angle, focal length, prism point, and a distortion factor of each of cameras 214 and 204. In an example, photographic images 216 and 206 may have been taken from satellites, vehicles, or airplanes, and the camera position and orientation may not be completely accurate. Alternatively, one or both of photographic images 216 and 206 may have been taken by a user with only a general idea of where her camera was positioned when it took the photo. Further, one of photographic images 216 or 206 may have been provided by a user without any idea of where her camera was positioned when it took the photo.

A photogrammetry algorithm may be used to solve both the camera parameters or pose data representing the cameras that took the photographic images and geometric parameters representing the three-dimensional model. This may represent a large and complex non-linear optimization problem. In cases where pose data for an image is inaccurate, pose data for an image may be improved or adjusted using constraints input by users. In cases where the camera parameters are inaccurate or missing from a user-provided image, camera parameters or pose data may be automatically determined using computer vision techniques.

Once three-dimensional model 202 is created, computer vision techniques may be used to detect features in a user-provided image and correlate detected features with features of the model to determine pose data for the user-provided image. For example, computer vision techniques may detect corners or point features in a user-provided image such as image 216. Further, computer vision techniques may correlate detected features to features of the determined geometry of the model the model of the building. For example, the point specified by reference 218 may be a detected feature representing a corner of a building in a user-provided image, which may be matched with the corner of the three-dimensional model specified by reference 230. Based on the correlation, photogrammetry may be used to determine pose data for the user-provided image.

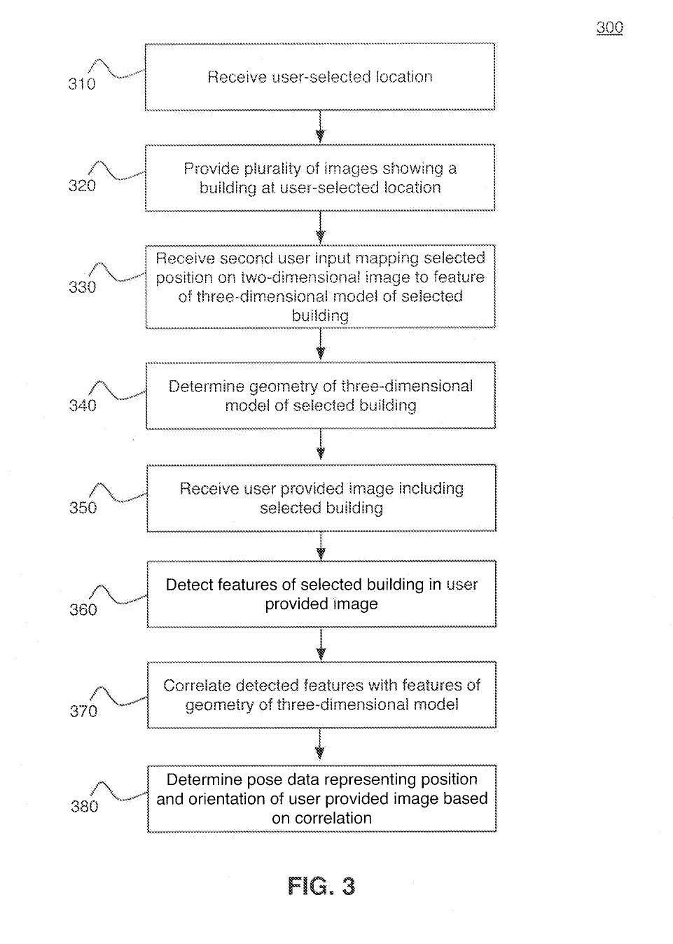

FIG. 3 is a flowchart showing a method 300 for determining pose data for a user-provided image using computer vision techniques. Method 300 begins at step 310, where a first user input including a user-selected location is received. The first input may be an address, a latitude and longitude location, or may correspond to a user navigating on a map in a geographical information system to a selected location.

At step 320, a plurality of images is provided to the user. Each of the plurality of images shows a building at the user-selected location. For example, images 112, 114, 116, and 118 may be provided for display to the user, each of which shows building 102. The plurality of images may be presented in a user interface 100.

At step 330, a second user input is received. The second user input may map a selected position on a two-dimensional image from the plurality of images provided at step 320 to a selected feature of a three-dimensional model of a selected building in the image. As described above, the user may select an image to display in a viewport. The user may model a building using one or more three-dimensional shapes, such as a box. At step 330, the user may map a position on one of the images provided at step 320 to a feature of the box to model the building three-dimensionally. The second user input may include constraint points for the selected feature of the three-dimensional model of the building.

At step 340, based on the mapping at step 330, a geometry of a three-dimensional model of the selected building may be determined. The geometry may be determined such that when the three-dimensional model is rendered with the two-dimensional image, from a perspective specified by a pose of the two-dimensional image, the feature of the three-dimensional model appears at the selected position of the two-dimensional image. For example, the geometry of the three-dimensional model may be determined using photogrammetry. As described above, the geometry of the three-dimensional model may be specified by a set of geometric parameters.

At step 350, a user-provided image is received. The user-provided image may have been captured by a user's digital camera and uploaded via a user's browser. Further, the user-provided image may be a scanned photograph. The user-provided image may also be an image captured from a moving camera. The user-provided image includes the building for which the geometry was determined at step 340.

At step 360, one or more features of the selected building in the user-provided image are detected. Detected features may include, but are not limited to, edge features, point features, or facades. Point features may include corners or areas where two or more edges of a building meet, for example, where a corner of a roof line is seen in the image. Edge features may include features where two facades meet, for example, where a front facade and side facade of the building meet. Facade features may include features that are surrounded by three or more edges of a model, or two edges and an area where the model meets the ground. Facade features may also include areas defined by two-dimensional shapes such as parallelograms. Feature detection is further described below.

At step 370, features detected at step 360 are correlated with the geometry of the model of the building determined at step 340. For example, a corner of a building in the user-provided image may be correlated with a corner of the geometry of the model of the building determined at step 340. Similarly, an edge feature of the building in the user-provided image may be correlated with an edge of the geometry.

At step 380, based on the correlation of step 370, pose data of the user-provided image is determined. The pose data may include a position and orientation of a camera which took the user-provided image. The pose data may further include a focal length of a camera which took the user-provided image, and a global positioning system (GPS) location for the image. The pose data may be determined such that, when the model of the building is rendered with the user-provided image from a perspective specified by the pose data, the features of the geometry of the building appear at the correlated detected feature of the selected building in the user-provided image. That is, the features of the model of the building may line up closely or exactly with the features of the building in the user-provided image.

Providing accurate pose data for the user-provided image may allow the user to quickly perform further modeling of the building. For example, if the user-provided image is poorly posed, she may spend a large amount of time adjusting the geometry of the model to line up with the features in the user-provided image. With accurate pose data associated with the user-provided image, the user may easily constrain the geometry of the model of the building to the user-provided image.

Feature detection, as described with reference to step 360 of method 300, may be performed by computer vision techniques. For example, scale-invariant feature transform, or SIFT, may be used to detect point features in the user-provided image. Further, speeded up robust features (SURF) may be used to detect features in the user-provided image. As described above, a point feature of a building in the user-provided image may be a corner of the building. Point features of the building in the user-provided image may be any other location on the image as well.

Computer vision techniques such as Canny edge detection or Burns Line Finder may be used to detect lines or edges in the user-provided image. Detected edges of a building in the user-provided image may be where the building meets the ground, or the roof line of the building, or where two facades of the building meet. As detailed above, facade features may be determined by identifying areas surrounded by three or more detected edges. Facade features may also be determined by identifying parallelograms in the building in the user-provided image.

Facade features may also be detected in accordance with step 360 of method 300. A facade may be specified by an area surrounded by three or more edges. A facade, such as a wall or roof, may also be detected by identifying parallelograms or similar two-dimensional shapes in the user-provided image.

Correlation of features in accordance with step 370 may be considered an optimization problem to be solved by a machine learning algorithm. For example, a classifier model may be used to score pose data values determined at step 380. The classifier model may return a higher score if the pose data values determined at step 380 cause the model of the building to be accurately rendered in the user-provided image. In an embodiment, a greedy or hill-climbing machine learning algorithm may be used. That is, pose data values may be adjusted while the score returned by the classifier model increases from the score of the immediate previous pose data values. In other embodiments, a random walk algorithm may be used. Other brute force machine learning algorithms may be used as well. For example, a machine learning algorithm may try a number of different values for the position and orientation of the camera for the user-provided image. Based on the score for each of the values, the machine learning algorithm may refine the range of values to try until optimal pose data values are determined.

The process of matching edge features may begin by drawing a wireframe of the geometry of the model of the building determined at step 340 into a blank image. Each edge of the geometry of the model may be drawn with a particular line thickness. Edge features detected and extracted from the user-provided image may be drawn with the same line thickness. An absolute pixel difference algorithm may deter-nine a score related to how closely the extracted edge features and the edges of the geometry match. The score may range from zero to one. A score of one may identify that the features match exactly, while a score of zero may identify that the features do not match at all. Various pose data values for the user-provided image may be tried until the score determined by the absolute pixel difference algorithm is one.

However, matching edges as specified above may, in certain situations, miss or never converge on optimal pose data values. This may occur because the the absolute pixel difference algorithm may only return a score of one if there is an exact match between edges, and zero in all other instances. Thus, in some embodiments, a Gaussian blur may be used to match edge features from the geometry of the model to detected features of the user-provided image. For example, a Gaussian blur of 3 pixels may be applied to the edge features of the geometry of the model and the detected edge features of the user-provided image. Applying a Gaussian blur may cause edges to appear as thicker and fuzzy lines that fall to black over their thickness. The score returned by the absolute pixel difference algorithm may then range between zero and one depending on the particular pose data values tried. The pose data values associated with the user-provided image may be those for which the score was closest to a value of one.

Pattern or texture matching of facades may also be possible to correlate features of the building in the user-provided image with features of the model. For example, windows of a building may be detected in the user-provided image. The current geometry of the model may be projected on to well-posed images to determine whether the configuration of windows in the projection matches the configuration of windows in the user-provided image. Pose data for the user-provided image may be adjusted until the windows of the building in the user-provided image line up with the configuration of windows in the model based on the well-posed imagery. Features other than windows, such as roofs, walls, or other building features may be matched as well.

For example, a determination may be made as to which wall of the building being modeled is present in the user-provided image. The two-dimensional shape or polygon of the same side of the geometry of the model of the building may be compared with the with the wall of the building in the user-provided image to determine a transform to apply to the two-dimensional shape of the model. The determined transform may represent the transform to be applied to the pose data values of the user-provided image.

In some embodiments, correlation of features in accordance with step 370 may begin with an initial guess of pose data values, based on certain heuristics. For example, a heuristic may specify that the pose data of the user-provided image would not reflect a position of the camera to be below the ground level surface. Further, a heuristic may be able to quickly determine whether an image is an aerial image or an image taken from ground level.

Based on the heuristics, a number of estimated position and orientation values may be used as estimated pose data values for the user-provided image. For each set of estimated pose data values, edges of the geometry may be drawn into the user-provided image, and a score may determine whether the estimated pose data values cause the edges to be accurately rendered. A brute force algorithm may modify the position and orientation values according to a specified increment, and in a particular range, until a maximum score is reached. Using the position and orientation values that returned the maximum score, the brute force algorithm may further modify the position and orientation values in a smaller increment, and a smaller range, to refine further the position and orientation values until a maximum score is reached.

In some embodiments, point features may be matched to determine pose data values for the user-provided image. A wireframe based on the geometry of the model determined at step 340 ray be drawn into a blank image. For each point in the wireframe, the closest point match in the user-provided image may be found. A pixel distance may be calculated from the particular point in the wireframe to the point in the user-provided image. The pixel distance may be used to determine the pose data values for the user-provided in-mage. In some embodiments, line features of the wireframe and line features detected in the user provide image may be decomposed into sets of point features, and matched as described above, to determine pose data values for the user-provided image.

In some embodiments, the user ray include pose data with the image she provides. However, this pose data may not be accurate. Embodiments may adjust the pose data for the user-provided image by matching features of the building in the image with features of the geometry of the model of the building. If pose data is included, the process of determining accurate pose data for the image may be quicker than if pose data is not included.

In addition to pose data for a user-provided image, other data may be associated with the user-provided image based on the correlation. For example, a GPS location for the user-provided image may be associated with the user-provided image, based on the correlation. As above, if the user has provided a GPS location with the image, the user-provided GPS location may be refined by way of the correlation.

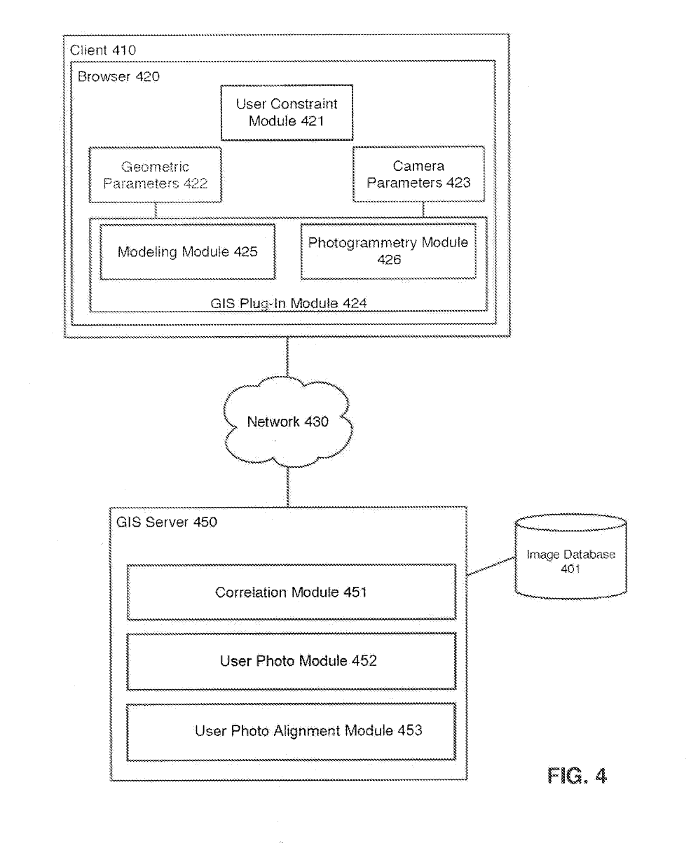

FIG. 4 is a diagram showing a system 400 for improving pose data for images in accordance with embodiments. System 400 may operate as described above with respect to FIGS. 1-3. System 400 may include a client 410 coupled to a GIS server 450 via one or more networks 430, such as the Internet. Client 410 includes a browser 420. Browser 420 includes a user constraint module 421, a GIS plug-in module 424, geometric parameters 422 and camera parameters 423. GIS plug-in module 424 includes a modeling module 425 and photogrammetry module 426. Each of these components is described below.

System 400 also includes image database 401. Image database 401 may store a collection of two-dimensional images used to model buildings. Images stored in image database 401 may be aerial or satellite images, or may have been captured from a moving vehicle. Further, images in image database 401 may be supplied by users. Images stored in image database 401 may be associated with pose data representing a position and orientation of the image. Image database 401 may be a relational or non-relational database. Images stored in image database 401 may be accessed by client 410 and browser 420 from GIS server 450 over network 430.

In embodiments, browser 420 may be a known Internet browser. The components of browser 420 may be downloaded from a server, such as a web server, and executed on client 410. For example, the components of browser 420 may be Hypertext Markup Language (HTML), JavaScript, or a plug-in, perhaps running native code. GIS plug-in module 424 may be a browser plug-in implementing a pre-specified interface and compiled into native code.

Upon receipt of a user selection indicating a particular location at which to create a three-dimensional model, in accordance with step 310 of method 300, modeling module 425 may display a plurality of images showing a building at the user-selected location, in accordance with step 320. User constraint module 421 may display an interface that may display photographic images of the area in conjunction with modeling module 425. User constraint module 421 and modeling module 425 may retrieve the images from GIS server 450 and image database 401.

GIS server 450 may include a web server. A web server is a software component that responds to a hypertext transfer protocol (HTTP) request with an HTTP reply. The web server may serve content such as hypertext markup language (HTML), extensible markup language (XML), documents, videos, images, multimedia features, or any combination thereof. This example is strictly illustrative and does not limit the embodiments described herein.

User constraint module 421, in conjunction with modeling module 425, may receive a user input mapping at least one position on a two-dimensional image received from GIS server 450 to a feature on a three-dimensional model, in accordance with step 330 of method 300. As described above, the two-dimensional image may be stored in image database 401. Mapping a position may also be known as inputting a constraint. Each constraint indicates that a position on the two-dimensional photographic image corresponds to a position on the three-dimensional model. In an embodiment, a user constraint module may receive a first user input specifying a first position on a first photographic image, and a second user input specifying a second position on a second photographic image. The second user input may further indicate that a feature located at the second position on the second photographic image corresponds to a feature located at the first position on the first photographic image.

Photogrammetry module 426 may, based on constraints received from user constraint module and modeling module 425, determine a geometry of a three-dimensional model of a building selected for modeling by a user. For example, as described with reference to FIG. 2, photogrammetry module 426 may determine rays based on user constraints to determine the geometry of a model.

User photo module 452 may receive a user-provided image, for example, a photograph taken by a user's digital camera that includes the building being modeled. In some embodiments, user photo module 452 may receive a user-provided image over network 430. Further, in some embodiments, user photo module 452 may receive an image from image database 401. For example, a user may select a photo stored in image database 401 for modeling purposes.

Correlation module 451 may detect features of a selected building in a user-provided image, in accordance with step 360 of method 300. For example, correlation module 451 may use SIFT, SURF, Canny edge detection, or Burns Line Finder, to detect features of the selected building. Correlation module 451 may further detect facade features of a selected building in a user-provided image.

In accordance with step 370 of method 300, correlation module 451 may also correlate detected features with the features of the geometry determined by photogrammetry module 426.

User photo alignment module 453 may determine pose data for the user-provided image in accordance with step 380 of method 300, based on the correlation determined by correlation module 451. The pose data may be calculated such that when the three-dimensional model is rendered with the user-provided image from a perspective specified by the pose data, each of the one or more features of the three-dimensional model appears at the correlated detected feature of the user-provided image. Pose data may be also calculated, in some embodiments by photogrammetry module 426.

In some embodiments, correlation module 451, user photo module 452, and user photo alignment module 453 may be provided as part of GIS server 450. In other embodiments, correlation module 451, user photo module 452, and user photo alignment module 453 may be provided as part of GIS plug-in module 424 and execute within browser 420 running on client 410.

Each of client 410 and GIS server 450 may be implemented on any computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a general purpose processor, graphics processor, memory and graphical user interface display. The computing device may also have multiple processors and multiple shared or separate memory components. For example, the computing device may be a clustered computing environment or server farm.

Each of browser 422, user constraint module 421, GIS plug-in module 424, modeling module 425, and photogrammetry module 426 may be implemented in hardware, software, firmware, or any combination thereof.

Each of geometric parameters 422 and camera parameters 423 may be stored in any type of structured memory, including a persistent memory, or a database. In examples, each database may be implemented as a relational database.

The Summary and Abstract sections may set forth one or more but not all exemplary embodiments of the present invention as contemplated by the inventor(s), and thus, are not intended to limit the present invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer implemented method of determining pose data for a user-provided image, comprising:
(a) providing, by one or more computing devices, a plurality of images, each of the plurality of images showing one or more buildings at a user-selected location;
(b) receiving, by the one or more computing devices, a manually selected user input mapping a selected position on a two-dimensional image in the plurality of images to a feature of a three-dimensional shape for a selected building in the two-dimensional image, the user input representing the user's indication that the manually selected position corresponds to the feature of the three-dimensional shape;
(c) creating, by the one or more computing devices, a three-dimensional model of the selected building at least in part by determining, with a photogrammetry algorithm, a geometry of the three-dimensional model based on the mapping such that, when the three-dimensional model is rendered with the two-dimensional image from a perspective specified by a pose of the two-dimensional image, the feature of the three-dimensional model appears at the selected position of the two-dimensional image, wherein the photogrammetry algorithm determines rays from the user mapping to determine the geometry of the three-dimensional model of the selected building, wherein the geometry of the three-dimensional model determined based on the user mapping is specified by a geometric parameter representing at least one of a scale, a shape, an origin point of an orientation of the three-dimensional model;
(d) receiving, by the one or more computing devices, a user-provided image, wherein the user-provided image includes the selected building;
(e) detecting, by the one or more computing devices, one or more features of the selected building in the user-provided image;
(f) correlating, by the one or more computing devices, the detected features of the selected building in the user-provided image with one or more features of the geometry of the three-dimensional model; and
(g) determining, by the one or more computing devices, pose data representing at least a position and orientation of the user-provided image based on the correlation such that, when the three-dimensional model is rendered with the user-provided image from a perspective specified by the pose data, each of the one or more features of the geometry of the three-dimensional model appear at the correlated detected feature of the selected building in the user-provided image.

2. The method of claim 1, further comprising receiving a user input comprising a user-selected location.

3. The method of claim 1, wherein the pose data further represents a camera focal length.

4. The method of claim 1, wherein the pose data further represents a global positioning system (GPS) location.

5. The method of claim 1, wherein the one or more features of the selected building in the user-provided image comprises one or more edge features.

6. The method of claim 1, wherein the one or more features of the selected building in the user-provided image comprises one or more point features.

7. The method of claim 1, wherein the one or more features of the selected building in the user-provided image comprises one or more facades.

8. The method of claim 6, wherein each of the one or more facades is defined by three or more edge features.

9. The method of claim 1, wherein the user-provided image is associated with a user-provided location for the image.

10. The method of claim 1, wherein the plurality of images comprises one or more of an oblique aerial photograph of the Earth, a panoramic photograph taken from street-level, or a photograph inputted by a user.

11. A system for determining pose data for a user-provided image, comprising:
one or more processors;
a modeling module implemented using the one or more processors that:
displays a plurality of images, each of the plurality of images showing one or more buildings at a user-selected location;
a user constraint module implemented using the one or more processors that:
receives a manually selected user input mapping a selected position on a two-dimensional image in the plurality of images to a feature of a three-dimensional shape for a selected building in the two-dimensional image, the user input representing the user's indication that the manually selected position corresponds to the feature of the three-dimensional shape;
a photogrammetry module implemented using the one or more processors that:
creates a three-dimensional model of the selected building at least in part by determining a geometry of the three-dimensional model based on the mapping such that, when the three-dimensional model is rendered with the two-dimensional image from a perspective specified by a pose of the two-dimensional image, the feature of the three-dimensional model appears at the selected position of the two-dimensional image, wherein the photogrammetry module determines rays from the user mapping to determine the geometry of the three-dimensional model of the selected building, wherein the geometry of the three-dimensional model determined based on the user mapping is specified by a geometric parameter representing at least one of a scale, a shape, an origin point or an orientation of the three-dimensional model;
a user photo module implemented using the one or more processors that:
receives a user-provided image, wherein the user-provided image includes the selected building;
a correlation module implemented using the one or more processors that:
detects one or more features of the selected building in the user-provided image;
correlates the detected features of the selected building in the user-provided image with one or more features of the geometry of the three-dimensional model; and
a user photo alignment module implemented using the one or more processors that:
determines pose data representing at least a position and orientation of the user-provided image based on the correlation such that, when the three-dimensional model is rendered with the user-provided image from a perspective specified by the pose data, each of the one or more features of the geometry of the three-dimensional model appear at the correlated detected feature of the selected building in the user-provided image.

12. The system of claim 11, wherein the pose data further represents a camera focal length.

13. The system of claim 11, wherein the pose data further represents a global positioning system (GPS) location.

14. The system of claim 11, wherein the one or more features of the selected building in the user-provided image comprises one or more edge features.

15. The system of claim 11, wherein the one or more features of the selected building in the user-provided image comprises one or more point features.

16. The system of claim 11, wherein the one or more features of the selected building in the user-provided image comprises one or more facades.

17. The system of claim 16, wherein each of the one or more facades is defined by three or more edge features.

18. The system of claim 11, wherein the user-provided image is associated with a user-provided location for the image.

19. The system of claim 11, wherein the plurality of images comprises one or more of an oblique aerial photograph of the Earth, a panoramic photograph taken from street-level, or a photograph inputted by a user.

20. A non-transitory computer readable storage medium having instructions stored thereon that, when executed by a processor, cause the processor to perform operations including:
(a) providing a plurality of images, each of the plurality of images showing one or more buildings at a user-selected location;
(b) receiving a manually selected user input mapping a selected position on a two-dimensional image in the plurality of images to a feature of a three-dimensional shape for a selected building in the two-dimensional image, the user input representing the user's indication that the manually selected position corresponds to the feature of the three-dimensional shape;
(c) creating a three-dimensional model of the selected building at least in part by determining with a photogrammetry algorithm a geometry of the three-dimensional model based on the mapping such that, when the three-dimensional model is rendered with the two-dimensional image from a perspective specified by a pose of the two-dimensional image, the feature of the three-dimensional model appears at the selected position of the two-dimensional image, wherein the photogrammetry algorithm determines rays from the user mapping to determine the geometry of the three-dimensional model of the selected building, wherein the geometry of the three-dimensional model determined based on the user mapping is specified by a geometric parameter representing at least one of scale, a shape, an origin point or an orientation of the three-dimensional mode;
(d) receiving a user-provided image, wherein the user-provided image includes the selected building;
(e) detecting one or more features of the selected building in the user-provided image;
(f) correlating the detected features of the selected building in the user-provided image with one or more features of the geometry of the three-dimensional model; and
(g) determining pose data representing at least a position and orientation of the user-provided image based on the correlation such that, when the three-dimensional model is rendered with the user-provided image from a perspective specified by the pose data, each of the one or more features of the geometry of the three-dimensional model appear at the correlated detected feature of the selected building in the user-provided image.

21. A computer implemented method of determining pose data for a user-provided image, comprising:
(a) providing, by one or more computing devices, a plurality of images, each of the plurality of images showing one or more buildings at a user-selected location;
(b) receiving, by the one or more computing devices, manually selected user input mapping a selected position on a two-dimensional image in the plurality of images to a feature of a three-dimensional shape for a selected building in the two-dimensional image, the user input representing the user's indication that the manually selected position corresponds to the feature of the three-dimensional shape;
(c) receiving with a, photogrammetry algorithm, by the one or more computing devices, a geometry of a newly created three-dimensional model of the selected building that was determined based on the mapping such that, when the three-dimensional model is rendered with the two-dimensional image from a perspective specified by a pose of the two-dimensional image, the feature of the three-dimensional model appears at the selected position of the two-dimensional image, wherein the photogrammetry algorithm determines rays from the user mapping to determine the geometry of the three-dimensional model of the selected building, wherein the geometry of the three-dimensional model determined based on the user mapping is specified by a geometric parameter representing at least one of a scale, a shape, an origin point or an orientation of the three-dimensional model;
(d) receiving, by the one or more computing devices, a user-provided image, wherein the user-provided image includes the selected building;
(e) detecting, by the one or more computing devices, one or more features of the selected building in the user-provided image;
(f) correlating, by the one or more computing devices, the detected features of the selected building in the user-provided image with one or more features of the geometry of the three-dimensional model; and
(g) determining, by the one or more computing devices, pose data representing at least a position and orientation of the user-provided image based on the correlation such that when the three-dimensional model is rendered with the user-provided image from a perspective specified by the pose data, each of the one or more features of the geometry of the three-dimensional model appear at the correlated detected feature of the selected building in the user-provided image.
